(19) United States
(12) Patent Application Publication
(10) Pub. No.: US 2017/0233553 A1
(43) Pub. Date: Aug. 17, 2017

(54) MODIFIED CARBONATES FOR IMPROVED POWDER TRANSPORTATION AND DRY-BLEND STABILITY

(71) Applicant: Imerys USA, Inc., Roswell, GA (US)

(72) Inventors: Douglas WICKS, Johns Creek, GA (US); David ANSTINE, Canton, GA (US); Christopher PAYNTER, Atlanta, GA (US); David TAYLOR, Marietta, GA (US); Eric ERNST, Marietta, GA (US); David SKELHORN, Cumming, GA (US)

(21) Appl. No.: 15/518,702

(22) PCT Filed: Oct. 21, 2015
(86) PCT No.: PCT/US2015/056553

§ 371 Date: Apr. 12, 2017

Related U.S. Application Data
(60) Provisional application No. 62/187,838, filed on Jul. 2, 2015.
(60) Provisional application No. 62/067,286, filed on Oct. 22, 2014.
(60) Provisional application No. 62/067,278, filed on Oct. 22, 2014.

(51) Int. Cl. C08K 9/04; C08K 5/06; C08K 3/26

(52) U.S. Cl. CPC C08K 9/04; C08K 3/26; C08K 5/06; C08K 2003/265

(57) ABSTRACT

A functional filler composition for use with a vinyl chloride polymeric resin may include a treated alkali earth metal carbonate and a humectant. A method of forming a filled vinyl chloride-based polymer article may include mixing a vinyl chloride-based polymeric resin with a filler composition and forming a polymer article from the mixture. The filler composition comprising a treated alkali earth metal carbonate and a humectant. A surface treatment of the treated alkali earth metal carbonate includes at least a monolayer concentration of the surface treatment.

### CLAIM FOR PRIORITY

This PCT International Application claims the benefit of priority of U.S. Provisional Patent Application Nos. 62/067,278, filed Oct. 22, 2014, 62/067,288, filed Oct. 22, 2014, and 62/187,838, filed Jul. 2, 2015, the subject matter of all of which is incorporated herein by reference in its entirety.

### FIELD OF DISCLOSURE

This disclosure relates to compositions for use in transporting and processing functional fillers for use with polymeric resins, such as vinyl chloride-based polymeric resins.

### BACKGROUND OF THE DISCLOSURE

Commercial products can be formed from polymeric resins. Polymeric resins may be used in melt processing, in which the polymeric resin is melted down and processed to form, for example, molded articles, monofilament fibers, or polymer films. Commercial products can also be formed from polymeric films, such as for packaging or protective layers. For instance, polymeric-based products may be used to make staple fibers, yarns, fishing line, woven fabrics, non-woven fabrics, artificial furs, diapers, feminine hygiene products, adult incontinence products, artificial turf, packaging materials, wipes, towels, industrial garments, medical drapes, medical gowns, foot covers, sterilization wraps, table cloths, paint brushes, napkins, trash bags, various personal care articles, pipes, gloves, automotive parts, toys, fasteners, and many other household, industrial, or commercial products.

Commercial industries consume a large amount of thermoplastic polymeric resin each year, which may incorporate various mineral fillers, such as calcium carbonate, during production of fibrous products, polymeric films, and molded parts. In modern processes, increasing polymeric resin prices have created cost-benefits associated with increasing the quantity of mineral fillers and decreasing the quantity of resin in many products. By incorporating at least one mineral filler, the required amount of virgin polymer resin material decreases while the end product may have comparable quality in areas such as strength, texture, and appearance.

Calcium carbonate (CaCO₃) is a commonly used filler/extender for the polymer industry. In order to reduce the cost of the filler materials used, a filler material may not include a surface treatment when processing certain polymers, such as vinyl chloride-based polymers. However, filler compositions may clump or agglomerate due to moisture pick-up by the calcium carbonate or due to reduced static forces on the calcium carbonate.

Prior to the processing, the carbonate filler may be transported in dry form. The carbonate particles may be susceptible to moisture pick-up, which may cause the particles to stick together. Additional moisture may also cause clumps to form in the fillers. The filler may also be susceptible to processing problems caused by friction as the carbonate passes through the delivery pipes during processing. The moisture pick-up susceptibility, clump formation, and reduction of static charges may create processing disruptions, which can reduce or negate the cost savings of using an untreated filler composition. For example, too little filler may be added to a polymeric resin if a blockage inhibits the flow of the filler in the processing equipment or too much filler may be added if the filler forms clumps that pass into the polymer or if a blockage breaks down and passes into the polymeric resin. In addition, when blockages break down and pass into the polymeric resin, the blockage may be a large agglomerate that disrupts the processing, texture, or smoothness of the finished polymer. The output of a compounding line may also be reduced because machine operators must shut down the line to clear blockages and restore proper flow.

Therefore, it may be desirable to provide a filler composition that reduces clumping and/or processing problems of the filler composition. It may also be desirable to provide a filler composition with improved handling and transportation characteristics with improved stability. It may also be desirable to provide a method for processing a polymeric resin, such that the flow properties of the dry filler are improved.

### SUMMARY OF THE DISCLOSURE

In the following description, certain aspects and embodiments will become evident. It should be understood that the aspects and embodiments, in their broadest sense, could be practiced without having one or more features of these aspects or embodiments. It should be understood that these aspects and embodiments are merely exemplary.

According to an aspect of this disclosure, a functional filler composition for use with a vinyl chloride polymeric resin may include a treated alkali earth metal carbonate and a humectant.

According to still a further aspect, a method of forming a filled vinyl chloride-based polymer article may include mixing a vinyl chloride-based polymeric resin with a filler composition, wherein the filler composition may include a treated alkali earth metal carbonate and a humectant, and forming a polymer article from the mixture.

### BRIEF DESCRIPTION OF THE DRAWINGS

FIG. 1 shows a chart of static charge of exemplary compositions.

### DESCRIPTION OF EXEMPLARY EMBODIMENTS

Reference will now be made in detail to exemplary embodiments.

According to some embodiments, a functional filler composition for use with a vinyl chloride polymeric resin may include a treated alkali earth metal carbonate and a humectant.

According to some embodiments, a method of forming a filled vinyl chloride-based polymer article may include mixing a vinyl chloride-based polymeric resin with a filler composition, wherein the filler composition may include a treated alkali earth metal carbonate and a humectant, and forming a polymer article from the mixture. Forming the polymer article from the mixture may include extruding the mixture to form the polymer article.

According to some embodiments, a surface treatment of the treated alkali earth metal carbonate may include at least a monolayer concentration of the surface treatment. According to some embodiments, a surface treatment of the treated alkali earth metal carbonate may include less than a monolayer concentration of the surface treatment.

Alkali Earth Metal Carbonate

A filler material may include an alkali earth metal carbonate. The alkali earth metal carbonate may include a carbonate of calcium, magnesium, barium, or strontium, or a carbonate of two or more alkaline earth metals, e.g., obtained from dolomite. Hereafter, certain embodiments may tend to be discussed in terms of calcium carbonate, and/or in relation to aspects where the calcium carbonate is processed and/or treated. The invention should not be construed as being limited to such embodiments and may be applicable to any alkali earth metal carbonate.

A calcium carbonate-containing material may be produced in a known way from marble, chalk, limestone, dolomite, calcite, aragonite, precipitated calcium carbonate (PCC), or ground calcium carbonate (GCC). A magnesium carbonate may be produced from, for example, magnesite. The alkali earth metal carbonate may also include a synthetic alkali earth metal carbonate, such as, for example, synthetic calcium carbonate produced as a precipitate by a reaction of calcium hydroxide and carbon dioxide in a known way.

In some embodiments, the alkali earth metal carbonate may be a ground carbonate. The ground carbonate may be prepared by attrition grinding. “Attrition grinding,” as used herein, refers to a process of wearing down particle surfaces resulting from grinding and shearing stress between the moving grinding particles. Attrition can be accomplished by rubbing particles together under pressure, such as by a gas flow. In some embodiments, the attrition grinding may be performed autogenously, where the alkali earth metal carbonate particles are ground only by other alkali earth metal carbonate particles of the same type (e.g., calcium carbonate being ground only by calcium carbonate).

According to another embodiment, the alkali earth metal carbonate may be ground by the addition of a grinding media other than calcium carbonate. Such additional grinding media can include ceramic particles (e.g., silica, alumina, zirconia, and aluminum silicate), plastic particles, or rubber particles.

In some embodiments, the calcium carbonate is ground in a mill. Exemplary mills include those described in U.S. Pat. Nos. 5,238,193 and 6,634,224. As described in these patents, the mill may include a grinding chamber, a conduit for introducing the calcium carbonate into the grinding chamber, and an impeller that rotates in the grinding chamber, thereby agitating the calcium carbonate.

In some embodiments, the calcium carbonate is dry ground, such as, for example, where the atmosphere in the mill is ambient air. In some embodiments, the calcium carbonate may be wet ground.

The ground calcium carbonate may be further subjected to an air sifter or hydrocyclone. The air sifter or hydrocyclone can function to classify the ground calcium carbonate and remove a portion of residual particles greater than, for example, 10 microns. According to some embodiments, the classification can be used to remove residual particles greater than 50 microns, greater than 40 microns, greater than 30 microns, greater than 20 microns, greater than 15 microns, or greater than 5 microns. According to some embodiments, the ground calcium carbonate may be classified using a centrifuge, hydraulic classifier, or elutriator.

In some embodiments, the ground calcium carbonate disclosed herein may be free of dispersant, such as a polyacrylate. In another embodiment, a dispersant may be present in a sufficient amount to prevent or effectively restrict flocculation or agglomeration of the ground calcium carbonate to a desired extent, according to normal processing requirements. The dispersant may be present, for example, in levels up to about 1% by weight relative to the dry weight of the alkali earth metal carbonate. Examples of dispersants include polyelectrolytes such as polyacrylates and copolymers containing polyacrylate species, including polyacrylate salts (e.g., sodium and aluminium optionally with a Group II metal salt), sodium hexametaphosphates, non-ionic polyol, polyphosphoric acid, condensed sodium phosphate, non-ionic surfactants, alkanolamine, and other reagents commonly used for this function.

A dispersant may be selected from conventional dispersant materials commonly used in the processing and grinding of alkali earth metal carbonate, such as calcium carbonate. Such dispersants will be recognized by those skilled in this art. Dispersants are generally water-soluble salts capable of supplying anionic species, which in their effective amounts may adsorb on the surface of the alkali earth metal carbonate particles and thereby inhibit aggregation of the particles. The unsolvated salts suitably include alkali metal cations, such as sodium. Solvation may in some cases be assisted by making the aqueous suspension slightly alkaline. Examples of suitable dispersants also include water soluble condensed phosphates, for example, polymetaphosphate salts (general form of the sodium salts: (NaPO₃)ₓ), such as tetrasodium metaphosphate or so-called “sodium hexametaphosphate” (Graham's salt), water-soluble salts of polysilicic acids; polyelectrolytes; salts of homopolymers or copolymers of acrylic acid or methacrylic acid; or salts of polymers of other derivatives of acrylic acid, suitably having a weight average molecular mass of less than about 20,000. Sodium hexametaphosphate and sodium polyacrylate, the latter suitably having a weight average molecular mass in the range of about 1,500 to about 10,000, are preferred.

In certain embodiments, the production of the ground calcium carbonate includes using a grinding aid, such as propylene glycol, or any grinding aid known to those skilled in the art.

Surface Treatments

The alkali earth metal carbonate may be treated to include a treatment layer located on the surface of the alkali earth metal carbonate mineral. For example, a surface-treatment may include a fatty-acid coating. A surface treatment may include, for example, a treatment with an organic carboxylic acid. The organic carboxylic acid may have the following general structure:

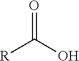

where R is a carbon-containing compound having from 6 to 40 carbon atoms, such as, for example, from 8 to 40 carbon atoms.

According to some embodiments, and organic carboxylic acid may include an aliphatic carboxylic acid, such as, for example, caproic acid, 2-ethylhexanoic acid, caprylic acid, neodecanoic acid, capric acid, valeric acid, lauric acid, myristic acid, palmitic acid, stearic acid, behenic acid, lignoceric acid, tall oil fatty acid, napthenic acid, montanic acid, coronaric acid, linoleic acid, linolenic acid, 4,7,10,13,16,19-docosahexaenoic acid, 5,8,11,14,17-eicosapentaenoic acid, hexanoic acid, heptanoic acid, octanoic acid, nonanoic acid, isononanoic acid, or combinations thereof. According to some embodiments, the aliphatic carboxylic acid may be a saturated or unsaturated aliphatic carboxylic acid.

According to some embodiments, the aliphatic carboxylic acid may include a mixture of two or more aliphatic carboxylic acids, such as, for example, a mixture of two or more of caproic acid, 2-ethylhexanoic acid, caprylic acid, neodecanoic acid, capric acid, valeric acid, lauric acid, myristic acid, palmitic acid, stearic acid, behenic acid, lignoceric acid, tall oil fatty acid, napthenic acid, montanic acid, coronaric acid, linoleic acid, linolenic acid, 4,7,10,13,16,19-docosahexaenoic acid, 5,8,11,14,17-eicosapentaenoic acid, hexanoic acid, heptanoic acid, octanoic acid, nonanoic acid, and isononanoic acid.

According to some embodiments, the weight ratio of a mixed aliphatic carboxylic acid including two component acids may range from about 90:10 to about 10:90 by weight, from about 80:20 to about 20:80, from about 70:30 to about 30:70, or from about 60:40 to about 40:60 by weight. According to some embodiments, the weight ratio of the component aliphatic carboxylic acids in an acid mixture may be about 50:50 by weight.

According to some embodiments, the aliphatic carboxylic acid may include one or more of a linear, branched, substituted, or non-substituted carboxylic acid. The aliphatic carboxylic acid may be chosen from aliphatic monocarboxylic acids. Alternatively or additionally, the aliphatic carboxylic acid may be chosen from branched aliphatic monocarboxylic acids.

According to some embodiments, the surface treatment may include an aromatic carboxylic acid, such as, for example, alkylbenzoic acid, hydroxybenzoic acid, aminobenzoic acid, protocatechuic acid, or combinations thereof.

According to some embodiments, the surface treatment may include a Rosin acid, such as, for example, palustrinic acid, neoabietic acid, abietic acid, or levopimaric acid.

According to some embodiments, R may include one or more of a straight chain or branched alkyl, phenyl, substituted phenyl, C6-40 alkyl substituted with up to four OH groups, C6-40 alkyl, amido, maleimido, amino or acetyl substituted hydrocarbon radicals.

According to some embodiments, the surface treatment may include a combination of one or more of an aliphatic carboxylic acid, an aromatic carboxylic acid, or a Rosin acid.

According to some embodiments, the organic carboxylic acid may be a liquid at room temperature, such as, for example, an organic carboxylic acid having a viscosity of less than 500 mPa.s at 23° C. when measured in a DV III Ultra model Brookfield viscometer equipped with the disc spindle 3 at a rotation speed of 100 rpm and room temperature (23±1° C.).

According to some embodiments, the alkali earth metal carbonate may be treated by forming a treatment layer including at least one organic carboxylic acid and/or one or more reaction products of at least one organic carboxylic acid on the surface of the alkali earth metal carbonate filler resulting in a treated alkali earth metal carbonate filler.

According to some embodiments, the treated alkali earth metal carbonate may include a stearate treatment, such as, for example, ammonium stearate, calcium stearate, barium stearate, magnesium stearate, strontium stearate, zinc stearate, aluminum stearate, zirconium stearate, or cobalt stearate. According to some embodiments, the treated alkali earth metal carbonate may include a salt of at least one of a valerate, stearate, laurate, palmitate, caprylate, neodecanoate, caproate, myristate, behenate, lignocerate, napthenate, montanate, coronarate, linoleate, docosahexaenoate, eicosapentaenoate, hexanoate, heptanoate, octanoate, nonanoate, isononanoate, or mixtures thereof, such as, for example, ammonium, calcium, barium, magnesium, strontium, zinc, aluminum, zirconium, or cobalt forms of the aforementioned salts.

According to some embodiments, the surface treatment may include a blend of a carboxylic acid and a salt of a carboxylic acid. According to some embodiments, the weight ratio of a mixed carboxylic acid and salt thereof may range from about 90:10 to about 10:90 by weight (acid:salt), from about 80:20 to about 20:80, from about 70:30 to about 30:70, or from about 60:40 to about 40:60 by weight (acid:salt). According to some embodiments, the weight ratio of carboxylic acid and salt in a mixture may be about 50:50 by weight (acid:salt).

According to some embodiments, the treated alkali earth metal carbonate filler may have a volatile onset temperature of greater than or equal to about 100° C. According to some embodiments, the treated alkali earth metal carbonate filler may have a volatile onset temperature of greater than or equal to about 130° C., greater than or equal to about 150° C., greater than or equal to about 160° C., greater than or equal to about 170° C., greater than or equal to about 200° C., greater than or equal to about 220° C., greater than or equal to about 250° C., greater than or equal to about 260° C., such as, for example, greater than or equal to 270° C., greater than or equal to 280° C., greater than or equal to 290° C., greater than or equal to 300° C., greater than or equal to 310° C., or greater than or equal to 320° C.

Polymeric Resin

As used in this disclosure, the terms “polymer,” “resin,” “polymeric resin,” and derivations of these terms may be used interchangeably.

According to some embodiments, the polymeric resin may be a vinyl chloride-based polymeric resin chosen from conventional vinyl chloride-based polymeric resins that provide the properties desired for any particular yarn, woven product, non-woven product, film, mold, or other applications.

According to some embodiments, the vinyl chloride-based polymeric resin may be a thermoplastic polymer, including but not limited to polyvinyl chloride (PVC). According to some embodiments, the vinyl chloride-based polymeric resin may include unplasticized polyvinyl chloride (uPVC). According to some embodiments, the vinyl chloride-based polymeric resin may include a chlorinated polyvinyl chloride polymeric resin.

According to some embodiments, the vinyl chloride-based polymeric resin may include a co-polymer, in which one of the polymers is a vinyl chloride-based polymer. For example, the vinyl chloride-based polymeric resin may include a co-polymer of polyvinyl chloride and at least one of ethylene-vinyl acetate (EVA), chlorinated polyethylene (CPE), acrylonitrile butadiene styrene (ABS), methacrylate butadiene styrene (MBS), Acrylonitrile butadiene rubber (NBR), thermoplastic polyurethane (TPU), Thermoplastic polyester elastomers (TPEE), or acrylic resins.

Treated Alkali Earth Metal Carbonate Fillers

Without wishing to be bound by a particular theory, it is believed that alkali earth metal carbonate fillers, such as, for example, calcium carbonate-containing mineral fillers, may be associated with processing problems, such as clumping and reduced static charge, that may result in buildups in processing equipment, creating blockages that affect the flow of filler to a polymer.

According to some embodiments, the adverse effects resulting from buildup of the carbonate filler composition may be mitigated or reduced by adding a humectant to the filler. A “humectant” is generally described as a molecule having hydrophilic groups that form hydrogen bonds with water molecules by absorbing water from the surrounding atmosphere. In general, humectants may increase the moisture content of products and compositions. Filler including humectant, according to some embodiments, may act as a process aid for melt-processing polymers for the formation of polymer articles, such as, for example, polymer pipe (e.g., polyvinyl chloride (PVC) pipe) and other polymer articles. For example, according to some embodiments, such filler including humectant may act as a process aid as defined by the Plastics Pipe Institute (PPI). For instance, the filler including humectant may be a pre-qualified ingredient exempted from stress-rupture testing for PVC pipe as defined by PPI Technical Reports TR-2 and TR-3. In other embodiments, the filler including humectant may be a process aid resulting in a PVC pipe having a hydrostatic design basis of 4,000 psi for water at 73° F. (23° C.) when evaluated according to ASTM D 2837, as defined by PPI Technical Reports TR-2 and TR-3.

For example, the filler including humectant according to some embodiments, may improve the flow, reduce clumping, and/or improve dry-blend stability (e.g., reduce separation of the functional filler and polymer) of powder, pellets, and/or granules including a polymer and the filler including humectant. In other embodiments, the filler including humectant may have improved dispersion in the polymer melt and/or polymer article as compared to a filler comprising only an untreated alkali earth metal. Improved flow and/or dispersion in the polymer, in turn, may provide improved control of the polymer formulation and/or process (e.g., dosing of the functional filler), which may increase permissible loading levels and/or loading consistency, and/or may improve throughput of the processing, thereby achieving higher running rates. In certain embodiments, the loading level of the filler including humectant in the polymer may be increased by at least 1%, or at least 10%, as compared to the loading level of a filler including only an untreated alkali earth metal. According to some embodiments, the filler including humectant may provide better wall control of polymer articles such as pipe (e.g., allowing more consistent wall thicknesses and/or production to tighter tolerances). According to some embodiments, the filler including humectant may result in maintaining and/or improving impact strength of the finished polymer article.

According to some embodiments, a functional filler composition for use with a vinyl chloride polymeric resin may include a treated alkali earth metal carbonate and a humectant.

According to some embodiments, a surface treatment of the treated alkali earth metal carbonate may include at least a monolayer concentration of the surface treatment. According to some embodiments, a surface treatment of the treated alkali earth metal carbonate may include less than a monolayer concentration of the surface treatment.

Without wishing to be bound by a particular theory, it is believe that by including a humectant in a treated filler composition, the additional moisture retained by the humectant may mitigate processing problems cause by the filler composition. It is also believed that the humectant may reduce the formation of clumps by absorbing water from the surrounding environment and preventing the carbonate particles from sticking together. The addition of the humectant to a filler composition may help in reducing the buildup of filler in processing equipment, thereby improving the processing characteristics of fillers used with vinyl chloride-based polymeric resins and improving process output by reducing downtime that results from cleaning blockages from the processing equipment.

According to some embodiments, the humectant may include one or more of ethylene glycol, propylene glycol, trimethylol propanol, glycerol, pentaerythritol, sucrose, sucrose isomers, pentose, pentose isomers, triethylene glycol, diethylene glycol, tripropylene glycol, dipropylene glycol, 1,3 propane diol, polyacrylamides, polyvinylacetates, polyvinylalcohols, toluene diisocyanate, diphenylmethane diisocyanate, polyethylene glycol, polyphenyl polymethylene polyisocyanates, or combinations thereof.

According to some embodiments, the amount of humectant in the filler composition may range from about 0.1% by weight to about 1% by weight relative to the weight of the treated alkali earth metal carbonate in the filler composition, such as, for example, from about 0.1% by weight to about 0.7% by weight or from about 0.2% by weight to about 0.5% by weight relative to the weight of the treated alkali earth metal carbonate in the filler composition.

According to some embodiments, a treated alkali earth metal carbonate may be treated with a monolayer concentration of the surface treatment. “Monolayer concentration,” as used herein, refers to an amount sufficient to form a monolayer on the surface of the alkali earth metal carbonate particles. Such values will be readily calculable to one skilled in the art based on, for example, the surface area of the alkali earth metal carbonate particles. According to some embodiments, a treated alkali earth metal carbonate may be treated with less than a monolayer concentration of the surface treatment. According to some embodiments, a treated alkali earth metal carbonate may be treated with in excess of a monolayer concentration of the surface treatment.

For example, the alkali earth metal carbonate may be surface treated in a treatment vessel containing a water-dry atmosphere in which the surface treatment is in a liquid (e.g., droplet) and/or vapor form. For example, calcium carbonate may be treated by exposing the calcium carbonate to a carboxylic acid, such as stearic acid, vapor or liquid. The amount of vapor or liquid in the reaction vessel may be controlled so as not to exceed a monolayer concentration of the surface treatment.

The mixture may be blended at a temperature sufficient for at least a portion of the carboxylic acid to react (e.g., sufficient for a majority of the carboxylic acid to react) with at least a portion of the calcium carbonate. For instance, the mixture may be blended at a temperature sufficient such that at least a portion of the carboxylic acid may coat at least a portion of the calcium carbonate (e.g., the surface of the calcium carbonate).

According to some embodiments, the alkali earth metal carbonate may be treated by exposing the surface of the alkali earth metal carbonate to the surface treatment agent in the reaction vessel at a temperature at which surface treatment is in a fluid or vaporized state. For example, the temperature may be in the range from about 20° C. to about 300° C., such as, for example, from about 25° C. to about 100° C., from about 50° C. to about 150° C., from about 100° C. to about 200° C., or from about 100° C. to about 150° C. The temperature selected in the atmosphere of the treatment vessel may provide sufficient heat to ensure melting and good mobility of the molecules of the surface treatment agent, and therefore, good contacting of and reaction with the surface of the alkali earth metal carbonate particles.

In some embodiments, a mixture of the alkali earth metal carbonate and carboxylic acid, such as stearic acid, may be blended at a temperature high enough to melt the carboxylic acid. For example, the alkali earth metal carbonate may be blended at a temperature in the range from about 65° C. to about 200° C. In other embodiments, the mixture may be blended at a temperature in the range from about 65° C. to about 150° C., for example, at about 120° C. In further embodiments, the mixture may be blended at a temperature in the range from about 65° C. to about 100° C. In still other embodiments, the mixture may be blended at a temperature in the range from about 65° C. to about 90° C. In further embodiments, the mixture may be blended at a temperature in the range from about 70° C. to about 90° C.

Surface treating the alkali earth metal carbonate may be carried out in a heated vessel in which a rapid agitation or stirring motion is applied to the atmosphere during the reaction of the surface treatment and with the alkali earth metal carbonate, such that the surface treatment agent is well dispersed in the treatment atmosphere. The agitation should not be sufficient to alter the surface area of the alkali earth metal carbonate because such an alteration may change the required surface treatment agent concentration to create, for example, a monolayer concentration. The treatment vessel may include, for example, one or more rotating paddles, including a rotating shaft having laterally extending blades including one or more propellers to promote agitation and deagglomeration of the carbonate and contacting of the carbonate with the surface treatment agent.

According to some embodiments, a treated calcium carbonate may be prepared by combining (e.g., blending) the carbonate with stearic acid and water at room temperature in an amount greater than about 0.1% by weight relative to the total weight of the mixture (e.g., in the form of a cake-mix). The mixture may be blended at a temperature sufficient for at least a portion of the stearic acid to react (e.g., sufficient for a majority of the stearic acid to react) with at least a portion of the surface of the calcium carbonate. For instance, the mixture may be blended at a temperature sufficient such that at least a portion of the stearic acid may coat the surface of the calcium carbonate in a monolayer concentration.

According to some embodiments, an alkali earth metal carbonate, such as calcium carbonate, may be combined (e.g., blended) at room temperature with stearic acid, or other carboxylic acid, and water in an amount greater than about 1% by weight relative to the total weight of the mixture (e.g., in the form of a cake-mix) to inhibit the formation of free stearic acid. For example, according to some embodiments, the mixture may be blended at a temperature sufficient for at least a portion of the stearic acid to react (e.g., sufficient for a majority of the acid to react, for example, with at least a portion of the calcium carbonate). For example, the mixture may be blended at a temperature sufficient such that at least a portion of the stearic acid may coat at least a portion of the calcium carbonate (e.g., the surface of the calcium carbonate). Treatment of an alkali earth metal carbonate with stearic acid and water is described U.S. Pat. No. 8,580,141 to Khanna et al.

Particle sizes, and other particle size properties, of the treated and untreated alkali earth metal carbonate, may be measured using a SEDIGRAPH 5100 instrument, as supplied by Micromeritics Corporation. The size of a given particle is expressed in terms of the diameter of a sphere of equivalent diameter, which sediments through the suspension, i.e., an equivalent spherical diameter or esd. The particle size of the treated alkali earth metal carbonate is expressed in terms of the particle size prior to the surface treatment.

According to some embodiments, the alkali earth metal carbonate, such as the treated alkali earth metal carbonate, may be characterized by a mean particle size (d₅₀) value, defined as the size at which 50 percent of the calcium carbonate particles have a diameter less than or equal to the stated value. In some embodiments, the treated alkali earth metal carbonate may have a d₅₀ in the range from about 0.1 micron to about 50 microns, such as, for example, in the range from about 0.1 micron to about 30 microns, from about 0.1 micron to about 20 microns, from about 0.1 micron to about 10 microns, from about 0.1 micron to about 5 microns, from about 0.1 micron to about 3 microns, from about 0.1 micron to about 2 microns, from about 0.1 micron to about 1 micron, from about 0.5 microns to about 2 microns, from about 1 micron to about 5 microns, from about 5 microns to about 20 microns, or from about 5 microns to about 10 microns.

According to some embodiments, the alkali earth metal carbonate, such as the treated alkali earth metal carbonate, may be characterized by a top cut size (d₉₈) value, defined as the size at which 98 percent of the calcium carbonate particles have a diameter less than or equal to the stated value. In some embodiments, the treated alkali earth metal carbonate may have a d₉₈ in the range from about 2 microns to about 100 microns, such as, for example, in the range from about 5 microns to about 50 microns, from about 2 microns to about 20 microns, or from about 5 microns to about 20 microns.

According to some embodiments, a treated alkali earth metal carbonate may be treated with an organic carboxylic acid or salt thereof, or a mixture of an organic carboxylic acid and salt of an organic carboxylic acid. For example, according to some embodiments, some or all of the stearic acid may be replaced by ammonium stearate, calcium stearate, barium stearate, magnesium stearate, strontium stearate, zinc stearate, aluminum stearate, zirconium stearate, or cobalt stearate. Other salts may include, for example, calcium valerate, barium valerate, magnesium valerate, strontium valerate, zinc valerate, aluminum valerate, zirconium valerate, or cobalt valerate, which may replace some or all of valeric acid. In some embodiments, some or all of the organic carboxylic acid may be replaced with a salt of the organic carboxylic acid. For example, some or all of the carbolxylic acid may be replaced by a salt of at least one of a valerate, stearate, laurate, palmitate, caprylate, neodecanoate, caproate, myristate, behenate, lignocerate, napthenate, montanate, coronarate, linoleate, docosahexaenoate, eicosapentaenoate, hexanoate, heptanoate, octanoate, nonanoate, isononanoate, or mixtures thereof, such as, for example, ammonium, calcium, barium, magnesium, strontium, zinc, aluminum, zirconium, or cobalt forms of the aforementioned salts. For example, the ratio of acid to salt may range from about 5:95 to about 95:5 (acid:salt) by weight, from about 10:90 to about 90:10 by weight, from about 80:20 to about 20:80 by weight, from about 70:30 to about 30:70 by weight, from about 60:40 to about 40:60 by weight, or from about 45:55 to about 55:45 by weight. According to some embodiments, all of the stearic acid (or other surface treatment) may be replaced by a salt, such as stearate, which may be used to create a monolayer concentration on the alkali earth metal carbonate.

The alkali earth metal carbonate, either before or after treatment, may be further subjected to an air sifter or hydrocyclone. The air sifter or hydrocyclone can function to classify the ground calcium carbonate and remove a portion of residual particles greater than 20 microns. According to some embodiments, the classification can be used to remove residual particles greater than 40 microns, greater than 30 microns, greater than 15 microns, greater than 10 microns, or greater than 5 microns. According to some embodiments, the ground calcium carbonate may be classified using a centrifuge, hydraulic classifier, or elutriator.

According to some embodiments, the various techniques for mitigating the adverse effects of sublimated stearic acid or other surface treatments described herein may be used in any combination. For example, a treated alkali earth metal carbonate may have some or all of an organic carboxylic acid replaced with a salt of the carboxylic acid.

According to some embodiments, the treated alkali earth metal carbonate may be optionally blended with an untreated alkali earth metal carbonate.

According to some embodiments, the treated alkali earth metal carbonate may include a first treated alkali earth metal carbonate and a second treated alkali earth metal carbonate. According to some embodiments, the first treated alkali earth metal carbonate may have a different surface treatment from the second alkali earth metal carbonate. According to some embodiments, the first treated alkali earth metal carbonate may have a surface treatment that may include at least a monolayer concentration of the surface treatment, and the second treated alkali earth metal carbonate may have a surface treatment that may include less than a monolayer concentration of the surface treatment.

According to some embodiments, the filler composition may have a static charge greater than or equal to about 1 kV/in after passing through 100 feet of 2 inch diameter PVC pipe, such as, for example, greater than or equal to about 2 kV/in, greater than or equal to about 3 kV/in, greater than or equal to about 4 kV/in, greater than or equal to about 5 kV/in, greater than or equal to about 6 kV/in, greater than or equal to about 7 kV/in, greater than or equal to about 8 kV/in, greater than or equal to about 9 kV/in, greater than or equal to about 10 kV/in after passing through 100 feet of 2 inch diameter PVC pipe. Static charge may be measured using a hand-held static meter, such as, a Model 212 hand-held static meter, manufactured by ETS.

According to some embodiments, a filler composition including treated alkali earth metal carbonate and a humectant may be used as a filler for a polymer product, such as, for example, a filler for a polymer fiber, film, extruded, or molded article.

According to some embodiments, the alkali earth metal carbonate filler may be incorporated into the vinyl chloride-based polymeric resin using any method conventionally known in the art or hereafter discovered. For example, alkali earth metal carbonate may be added to the vinyl chloride-based polymeric resin during any step prior to extrusion, for example, during or prior to the heating step or as a “masterbatch” in which the polymeric resin and the filler are premixed and optionally formed into granulates or pellets, and melted or mixed with additional virgin polymeric resin before forming a polymer-based article. According to some embodiments, the filler may be mixed with pellets or powders of the polymeric resin prior to, or during, transport or processing of the polymeric resin. According to some embodiments, the virgin polymeric resin may be the same or different from the vinyl chloride-based polymeric resin containing the filler.

According to some embodiments, the molten vinyl chloride-based polymer may then be continuously extruded through, for example, at least one spinneret to produce long filaments. Extrusion of the filled polymer from the spinnerets may be used to create, for example, a non-woven fabric. According to some embodiments, the molten vinyl chloride-based polymer may then be continuously extruded through a nozzle or dye to form polymeric articles, such as, for example, pipes, rods, honey-comb structures, or other articles having variously-shaped cross-sections. The extrusion rate may vary according to the desired application, and appropriate extrusion rates will be known to the skilled artisan.

According to some embodiments, a vinyl chloride-based polymeric film may be created from the molten, filled vinyl chloride-based polymer according to methods known in the art or hereinafter discovered. For example, melt compounding may also be used to extrude films, tubes, shapes, strips, and coatings onto other materials, injection molding, blow molding, or casting, and thermoforming and formation of tubes or pipes. The melt compounding may, for example, be carried out in, for example, a suitable compounder or screw extruder. A vinyl chloride-based polymer material to be compounded may suitably be in a granular or pelletized form. The temperature of the compounding and molding, shaping or extrusion processes will depend upon the thermoplastic material being processed and materials incorporated therein. The temperature will be above the softening point of the thermoplastic material,

According to some embodiments, filled vinyl chloride-based polymer compositions may be produced according to any appropriate process or processes now known to the skilled artisan or hereafter discovered. According to some embodiments, the filled vinyl chloride-based polymer may include a monofilament fiber. A monofilament fiber may include the production of a continuous monofilament fiber of at least one polymeric resin and at least one filler. Exemplary techniques include, but are not limited to, melt spinning, dry spinning, wet spinning, spinbonding, or meltblowing processes. Melt spinning may include an extrusion process to provide molten polymer mixtures to spinneret dies. According to some embodiments, monofilament fibers may be produced by heating the polymeric resin to at least about its melting point as it passes through the spinneret dies.

### EXAMPLE

Samples were prepared to determine the effect of a humectant on treated alkali earth metal filler compositions. Sample A was a calcium carbonate having a d₅₀ of 1.6 microns and treated with a monolayer concentration of stearic acid. Sample B was a calcium carbonate having a d₅₀ of 3 microns and treated with a monolayer concentration of stearic acid. Sample C was a calcium carbonate having a d₅₀ of 0.7 microns and treated with a monolayer concentration of stearic acid and also included a dispersant. Sample D was a calcium carbonate having a d₅₀ of 1.5 microns and treated with a monolayer concentration of stearic acid and also included a polyethylene glycol (PEG) humectant.

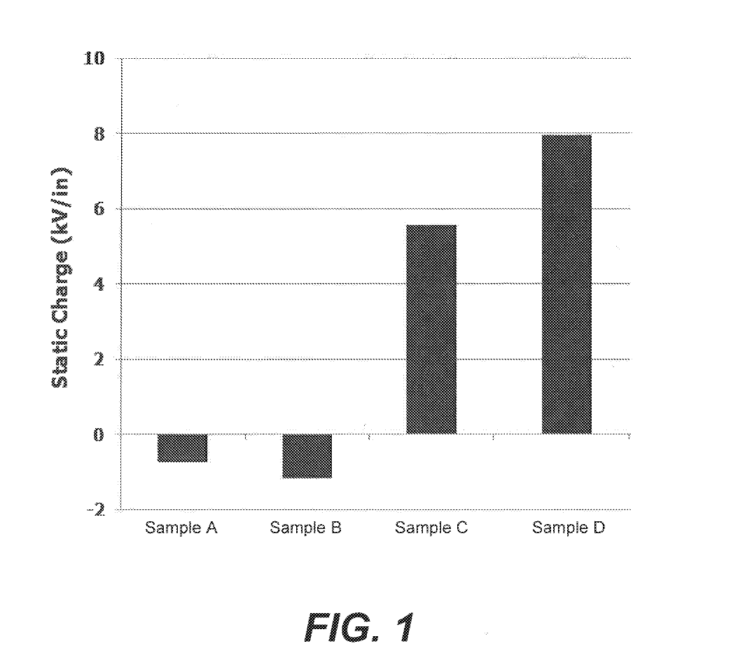

To determine the static charge of samples A-D, 200 grams of each sample was placed into a 2 inch diameter PVC pipe having a length of 5 feet, and with caps at both ends. For each sample, the pipe was rotated 20 times to simulate the flow of each sample passing through 100 feet of PVC pipe. After the final turn, each sample was placed into an insulated bucket and the static charge was measured using a hand-held static meter, Model 212, manufactured by ETS. FIG. 1 shows the static charge of each of samples A-D. As shown in FIG. 1, the static charge of sample D having a humectant was higher than the static charge of samples A-C. The static charge of sample D may indicate better processing characteristics of sample D relative to samples A-C, such as, for example, when sample D is used in the processing of a polymeric resin or polymeric resin powders.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed:

1. A functional filler composition, the functional filler composition comprising:
a treated alkali earth metal carbonate; and
a humectant,
wherein the functional filler composition improves the processing of a vinyl chloride-based polymeric resin.

2. The functional filler composition of claim 1, wherein the humectant is chosen from the group consisting of ethylene glycol, propylene glycol, trimethylol propanol, glycerol, pentaerythritol, sucrose, sucrose isomers, pentose, pentose isomers, triethylene glycol, diethylene glycol, tripropylene glycol, dipropylene glycol, 1,3 propane diol, polyacrylamides, polyvinylacetates, polyvinylalcohols, toluene diisocyanate, diphenylmethane diisocyanate, and polyphenyl polymethylene polyisocyanates.

3. The functional filler composition of claim 1, wherein the functional filler has a static charge greater than or equal to about 2 kV/inch after passing through 100 feet of 2 inch diameter PVC pipe.

4. The functional filler composition of claim 1, wherein the functional filler has a static charge greater than or equal to about 3 kV/inch after passing through 100 feet of 2 inch diameter PVC pipe.

5. The functional filler composition of claim 1, wherein the treated alkali earth metal carbonate comprises an alkali earth metal carbonate selected from the group consisting of calcium carbonate, magnesium carbonate, barium carbonate, or strontium carbonate.

6. The functional filler composition of claim 1, wherein the treated alkali earth metal carbonate has a median particle size in the range from about 0.1 micron to about 10 microns.

7. The functional filler composition of claim 1, wherein a surface treatment of the treated alkali earth metal carbonate comprises an organic carboxylic acid or salt thereof.

8. The functional filler composition of claim 7, wherein the organic carboxylic acid is chosen from the group consisting of caproic acid; 2-ethylhexanoic acid; caprylic acid; neodecanoic acid; capric acid; valeric acid; lauric acid; myristic acid; palmitic acid; stearic acid; behenic acid; lignoceric acid; tall oil fatty acid; napthenic acid; montanic acid; coronaric acid; linoleic acid; linolenic acid; 4,7,10,13,16,19-docosahexaenoic acid; 5,8,11,14,17-eicosapentaenoic acid, hexanoic acid, heptanoic acid, octanoic acid, nonanoic acid, isononanoic acid, and mixtures thereof.

9. The functional filler composition of claim 7, wherein the surface treatment comprises at least one of a valerate, stearate, laurate, palmitate, caprylate, neodecanoate, caproate, myristate, behenate, lignocerate, napthenate, montanate, corona ate, linoleate, docosahexaenoate, eicosapentaenoate, hexanoate, heptanoate, octanoate, nonanoate, isononanoate, or mixtures thereof.

10. The functional filler composition of claim 1, wherein the amount of humectant is in a range from about 0.1% by weight to about 1% by weight relative to the weight of the treated alkali earth metal carbonate.

11. A method of forming a filled vinyl chloride-based polymer article, the method comprising:
mixing a vinyl chloride-based polymeric resin with a filler composition, the filler composition comprising a treated alkali earth metal carbonate and a humectant; and
forming a polymer article from the mixture.

12. The method of claim 11, wherein the humectant is chosen from the group consisting of ethylene glycol, propylene glycol, trimethylol propanol, glycerol, pentaerythritol, sucrose, sucrose isomers, pentose, pentose isomers, triethylene glycol, diethylene glycol, tripropylene glycol, dipropylene glycol, 1,3 propane diol, polyacrylamides, polyvinylacetates, polyvinylalcohols, toluene diisocyanate, diphenylmethane diisocyanate, and polyphenyl polymethylene polyisocyanates.

13. The method of claim 11, wherein the filler composition has a static charge greater than or equal to about 2 kV/inch after passing through 100 feet of 2 inch diameter PVC pipe.

14. The method of claim 11, wherein the filler composition has a static charge greater than or equal to about 3 kV/inch after passing through 100 feet of 2 inch diameter PVC pipe.

15. The method of claim 11, wherein the treated alkali earth metal carbonate comprises an alkali earth metal carbonate selected from the group consisting of calcium carbonate, magnesium carbonate, barium carbonate, or strontium carbonate.

16. The method of claim 11, wherein the treated alkali earth metal carbonate has a median particle size in the range from about 0.1 micron to about 10 microns.

17. The method of claim 11, wherein a surface treatment of the treated alkali earth metal carbonate comprises an organic carboxylic acid or salt thereof.

18. The method of claim 17, wherein the organic carboxylic acid is chosen from the group consisting of caproic acid; 2-ethylhexanoic acid; caprylic acid; neodecanoic acid; capric acid; valeric acid; lauric acid; myristic acid; palmitic acid; stearic acid; behenic acid; lignoceric acid; tall oil fatty acid; napthenic acid; montanic acid; coronaric acid; linoleic acid; linolenic acid; 4,7,10,13,16,19-docosahexaenoic acid; 5,8,11,14,17-eicosapentaenoic acid, hexanoic acid, heptanoic acid, octanoic acid, nonanoic acid, isononanoic acid, and mixtures thereof.

19. The method of claim 17, wherein the surface treatment comprises at least one of a valerate, stearate, laurate, palmitate, caprylate, neodecanoate, caproate, myristate, behenate, lignocerate, napthenate, montanate, coronarate, linoleate, docosahexaenoate, eicosapentaenoate, hexanoate, heptanoate, octanoate, nonanoate, isononanoate, or mixtures thereof.

20. The method of claim 11, wherein the amount of humectant is in a range from about 0.1% by weight to about 1% by weight relative to the weight of the treated alkali earth metal carbonate.

21. The method of claim 11, wherein forming the polymer article from the mixture comprises extruding the mixture to form the polymer article.
